(19) United States
(12) Patent Application Publication
(10) Pub. No.: US 2008/0299359 A1
(43) Pub. Date: Dec. 4, 2008

(54) Moisture-Repellent Protective Layer For A Winding Head Of An Electric Machine

(75) Inventors: Bernhard Klaussner, Nurnberg (DE); Alexander Maurer, Nurnberg (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, München (DE)

(21) Appl. No.: 11/911,556

(22) PCT Filed: Apr. 7, 2006
(86) PCT No.: PCT/EP2006/061456

§ 371 Date: Jun. 27, 2008

(30) Foreign Application Priority Data
Apr. 13, 2005 (DE) 10 2005 017 112.5

(51) Int. Cl. B32B 3/10

(52) U.S. Cl. 428/206; 428/195.1

(57) ABSTRACT

The invention relates to a protective layer (13) for a winding head of an electric machine. Said protective layer consists of a moisture-repellent material that comprises a nanostructured surface (8) once it has been applied to the winding head, resulting in a water contact angle of at least 120 DEG.

The invention relates to a protective layer for a winding head of an electric machine.

A protective layer of this kind is provided for electrical insulation, for mechanical or chemical protection, or for protection against moisture on the winding head of an electric machine, designed for example as an electrodynamic motor or generator. Known protective layers are manufactured by means of partial multiple impregnation with impregnating resins and impregnating varnishes, or by means of casting with inorganically filled impregnating resins (=cast resin).

A protective layer made from a hard coating of a silicon-organic elastomer such as an organically modified silicone rubber material, which can be cured at room temperature, is described in DE 31 33 734 C2. The known protective layers tend to form cracks, for example when there are changes in temperature, and to delamination at least in some areas so that moisture can penetrate through the resulting cracks and cause extensive damage to the electric machine.

The object of the invention is therefore to specify a protective layer for a winding head of an electric machine, which provides improved protection against moisture.

This object is achieved by the characteristics of the independent patent claim 1. The protective layer according to the invention for a winding head of an electric machine is such a layer in which
a) a moisture-repellent protective layer material is provided, and
b) the protective layer material has a nanostructured surface once it has been applied to the winding head,
c) resulting in a water contact angle of at least 120°.

Because of the large water contact angle, the protective layer according to the invention is very strongly water-repellent. Due to the high degree of non-wettability of the nanostructured surface, the protective layer is also particularly referred to as superhydrophobic. The extreme water contact angle leads to the fact that, even if cracks should form in the protective layer, practically no moisture penetrates into the crack where it is responsible for consequential damage such as a reduction in the dielectric strength, a drop in the insulation resistance, a shortening of the creepage distances or even an electric breakdown. The same also applies to pores in the protective layer. Rather, the water drops remain on the nanostructured surface from where they run off.

Preferably, the protective layer according to the invention is able to be used in a force ventilated electric machine, the winding heads of which are at least partially directly subjected to a cooling air stream. This results in particularly high protection requirements with regard to moisture, saline mist, chemical substances and also abrasively acting dirt particles, which are carried to the winding head by means of the cooling air stream. The protective layer according to the invention provides very good protection with respect to these environmental influences. It also prevents the adhesion of other liquids, such as oils for example, and dirt particles. Rather, these foreign bodies can be conveyed out of the electric machine once more by means of the cooling air stream.

In addition, the protective layer according to the invention makes cleaning of the coated surfaces easier, as a result of which the use of chemically aggressive cleaning agents is unnecessary. This increases the life of the protective layer.

Advantageous embodiments of the protective layer according to the invention can be seen from the characteristics of the claims dependent on claim 1.

A variant in which the surface has a double structure is beneficial. In addition to the nanostructure, the surface then therefore has a further structure, for example a microstructure. This additionally increases the water contact angle. Values of 150° and more can be achieved in this way. Even a water contact angle of 170° can be realized in this manner.

According to another variant, the protective layer material has an electrically insulating behavior. This is particularly advantageous, because the winding head of the electric machine to be coated includes electrically active conductor arrangements. This means that the conductor arrangements carry current and are live during the operation of the electric machine. With the electrically insulating variant, insulation, which is otherwise provided in addition, can then be dispensed with. This reduces the manufacturing costs.

Preferably, the protective layer material is manufactured with a base material made from a silicone rubber, a polyesterimide or an unsaturated polyester resin.

In particular, the protective layer material contains surface-modified perfluorated particles, for example in the form of perfluorated compounds, which in particular are added to the abovementioned base material.

Preferably, the surface-modified perfluorated particles also have a mean grain diameter of about 10 nm.

Further characteristics, advantages and details of the invention can be seen from the following description of exemplary embodiments with reference to the drawing. In the drawing:

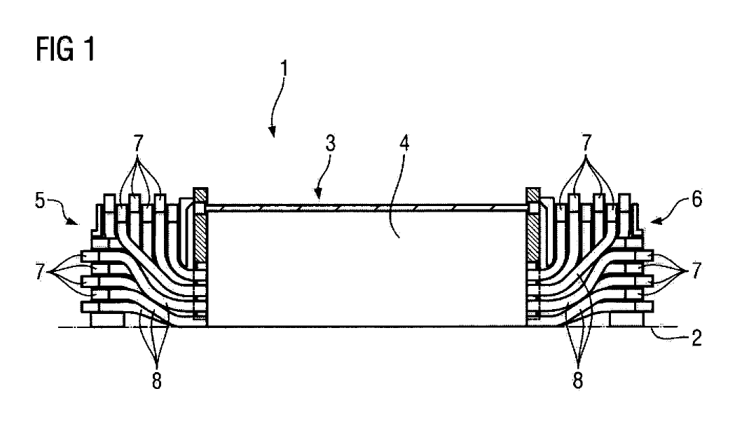

FIG. 1 shows an exemplary embodiment of an electric machine with winding heads, which include several protectively coated conductor arrangements, and

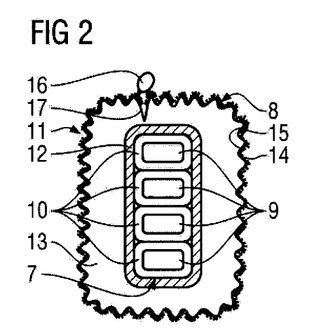

FIG. 2 shows an exemplary embodiment of a protective layer for the conductor arrangements according to FIG. 1 in cross section.

Corresponding parts are given the same references in FIGS. 1 and 2.

A partial cross section of an exemplary embodiment of an electric machine 1 is shown in FIG. 1. The section runs along an axis of rotation 2 through a stator 3 of the electric machine 1 and shows only part of the top half of the stator 3. An actually active area 4 with the iron laminations of the stator and the electric coil conductors guided in slots is not shown in detail but only schematically. The stator 3 has a winding head 5 and 6 respectively on the two axial sides of the active area 4.

The winding heads 5 and 6 are formed by a large number of electrical conductor arrangements 7, which are fed out of the iron laminations of the stator towards the axis of rotation 2. Coil windings are constructed by appropriate electrical connection of the conductor arrangements 7 in the area of the winding heads 5 and 6. The conductor arrangements 7 are coated in the area of the winding heads 5 and 6 for electrical insulation, for protection against moisture, saline mist, chemical substances and against abrasively acting dirt, wherein a nanostructured external surface 8 is provided.

The construction of several partial conductors 9, which are electrically insulated from one another, can be seen from the cross section through an exemplary embodiment of one of the conductor arrangements 7 shown in FIG. 2. The partial conductors 9 consist of copper bars. Each partial conductor 9 is enclosed by a partial conductor insulation 10 made of a Kapton film. In another exemplary embodiment, not shown, the conductor arrangement 7 can also include only one single conductor.

In the exemplary embodiment of FIG. 2, the conductor arrangement 7 is enclosed by a two-layer protective layer arrangement 11. It contains a first protective layer 12 made from a highly elastic silicone gel, and a second protective layer 13 made from a moisture-repellent protective layer material based on a silicone rubber, to which is added fine-grained surface-modified perfluorated compounds with a mean grain diameter of about 10 nm. The two protective layers 12 and 13 are produced as impregnation coatings. Basically, however, they can also be applied by means of other coating methods, for example by means of an electrostatic spray method.

The viscous silicone gel of the first protective layer 12 adheres very well to the conductor arrangement 7. It essentially eliminates mechanical stresses, which could otherwise lead to the formation of cracks and to delamination. In addition, it is to a certain extent self-healing.

The silicone-rubber-based protective layer material of the second protective layer 13 protects the gel-like first protective layer 12 and prevents adhesion of dirt particles, for example, to the relatively sticky silicone gel of the first protective layer 12. As both protective layers 12 and 13 consist of a silicone-based material, they adhere to each other particularly well.

Furthermore, the second protective layer 13 forms the outer surface 8, which in the exemplary embodiment has a double structure. As well as a nanostructure 14, it has a further structure, namely a microstructure 15, which is overlaid on the nanostructure 14. The microstructure 15 is not indispensable. However, it leads to a further improved water-repellent behavior of the surface. Overall, this then results in a very high water contact angle of about 150°, so that the second protective layer 13 and therefore also the protective layer arrangement 11 are very moisture-repellent overall. Even in the anyway extremely unlikely event of a crack forming, no water penetrates into the protective layer arrangement 11.

In the exemplary embodiment shown in FIG. 2, this is illustrated by a water drop 16, which lies on the surface 8 exactly above a crack 17. Because of the practically negligible wettability of the nanostructured and microstructured surface 8 and the surface tension of the water, the water drop 16 cannot get into the crack 17. It remains on the surface 8 from where it rolls off. Only a very slight inclination of the surface 8 or a cooling air stream of the electrical machine 1 is sufficient for this.

The protective layers 12 and 13 are electrically insulating. The protective layer arrangement 11 accordingly also carries out the function of the main electrical insulation so that an additional intermediate insulation layer can be dispensed with. This simplifies the construction, and the manufacturing costs are reduced.

However, in other exemplary embodiments, which are not shown, this intermediate insulation layer can be provided throughout. It then consists of winding the conductor arrangements 7 with mica tape. However, this winding is laborious, particularly in the area of the winding heads 5 and 6, and can often only be carried out by hand. On the other hand, the impregnation method or electrostatic spray method used for applying the protective layers 12 and 13 can be carried out without any problems in an automated manner.

The protective layer 13 according to the invention with the nanostructured surface 8 is therefore used for coating electrically active parts. While the electric machine 1 is in operation, the conductor arrangements 7 carry current and are live. In contrast with this, nanostructured layers, which are known up to now, have always been used on electrically non-active parts. As well as other advantages, the protective layer arrangement 11, which includes the protective layer 13 according to the invention, above all provides a durable moisture-resistant electrical insulation.

At the same time, the dielectric strength originates not only from the electrically insulating behavior of the protective coating material used, but also above all from the nanostructured surface 8. This prevents a penetration of moisture, and as a consequence thereof a failure of the electrical insulation, even if pores or cracks should form in the protective layer 13. The nanostructured surface 8 of the protective layer 13 therefore acts incidentally or indirectly in an electrically insulating manner, namely regardless of whether the protective layer material is an electrical insulator or not.

1.-6. (canceled)

7. A protective layer for a winding head of an electric machine, comprising a moisture-repellent protective layer material having an electrically insulating behavior, said protective layer material having a nanostructured surface when applied to a winding head, resulting in a water contact angle of at least 120°.

8. The protective layer of claim 7, wherein the nanostructured surface has a double structure.

9. The protective layer of claim 7, wherein the nanostructured surface has a microstructure to increase the water contact angle.

10. The protective layer of claim 9, wherein the water contact angle is at least 150°.

11. The protective layer of claim 9, wherein the water contact angle is 170°.

12. The protective layer of claim 7, wherein the protective layer material is based on a material selected from the group consisting of silicone rubber, polyesterimide, and unsaturated polyester resin.

13. The protective layer of claim 7, wherein the protective layer material contains surface-modified perfluorated particles.

14. The protective layer of claim 10, wherein the surface-modified perfluorated particles have a mean grain diameter of about 10 nm.
